(19) United States
(12) Patent Application Publication
(10) Pub. No.: US 2011/0020765 A1
(43) Pub. Date: Jan. 27, 2011

(54) ULTRASONIC TIP FOR DENTAL DEVICE

(76) Inventors: Randall Maxwell, Broken Arrow, OK (US); Charles E. Garrott, Tulsa, OK (US); W. Shane Mize, Kingsport, TN (US)

Correspondence Address: DENTSPLY INTERNATIONAL INC, 570 WEST COLLEGE AVENUE, YORK, PA, 17404, US

(21) Appl. No.: 12/771,419

(22) Filed: Apr. 30, 2010

Related U.S. Application Data
(60) Provisional application No. 61/174,258, filed on Apr. 30, 2009.

(51) Int. Cl. A61C 3/03

(52) U.S. Cl. 433/119

(57) ABSTRACT

A consumable tip assembly for use with a dental tool and a system for irrigation of a tooth root canal. The dental tool has an ultrasonic energy generator positioned therein. The tip assembly provides a single continuous flow path for delivering fluid from a reservoir at the proximal end of the needle to a root canal of a tooth at the distal end of the needle. Energy generated by an ultrasonic energy generator is translated into movement of a needle to provide optimum cleaning to the root canal. The system also includes a pressure source of irrigation fluid connected to the tip assembly. The irrigation fluid has ultrasonic energy imposed thereon as it passes through a hand piece of the dental tool.

### FIELD OF THE INVENTION

The present invention is directed to a device for performing dental procedures, and specifically to an ultrasonic tip useful for delivering and agitating irrigants in root canal therapy, i.e., endodontics

### BACKGROUND OF THE INVENTION

This invention relates to dental instruments and particularly to endodontic instruments, systems and procedures for treating a tooth root canal in which the root canal is cleansed of bacteriological materials by physical and acoustic debridgement and flushing with an irrigation solution, particularly the apparatus and equipment for providing irrigation to remove diseased and necrotic tissue.

Endodontic has become an important part of dentistry. Prior to the common use of endodontic procedures, an abscessed tooth was typically treated only by extraction of the tooth. However, since the advancement of endodontics, abscessed teeth can be successfully treated to permit retention by a patient, for greatly increased health and physiological benefit. Endodontics has been one of the great advances in modern medicine.

The endodontic preparation of a root canal typically includes opening the root canal through the coronal area of the tooth and thereafter manipulating files and reamers within the root canal to physically remove as much as possible of the pulpal material. This pulpal material is typically infected or necrotic, that is, dead material; and any such material that remains in the root canal after the procedure is completed is a source of potential infection. For this reason, proper treatment of a root canal attempts to remove as much of the necrotic pulpal material as is possible. By use of files and reamers, a substantial portion of such pulpal material can be removed; however, it is virtually impossible in most cases to remove all such material by physical manipulation of tools within the canal. For this reason, in recent times procedures have been developed wherein the root canal is irrigated or flushed with a fluid to remove and/or neutralize organic pulpal material that remains after files and reamers have been employed.

As background information, reference may be had to U.S. Pat. No. 4,330,278 that issued May 18, 1982 to Howard Martin, entitled “Endodontic Flow-through Ultrasonic Instrument Holder Device.” This device shows a system that includes a holder for holding an instrument used for dental work that includes a passageway by which flushing fluid can be injected into a tooth for endodontic procedures.

Another example of prior art, and one that teaches the use of ultrasonics in dental technology, is U.S. Pat. No. 6,948,935 entitled “Ultrasonic Dental Device.” This patent issued to John Nusstein on Sept. 27, 2005.

The present invention is an improvement on basic concepts as revealed in these and other United States patents.

### SUMMARY OF THE INVENTION

One aspect of the invention is directed to a tip assembly for use with a dental tool. The dental tool has an ultrasonic energy generator positioned therein. The tip assembly has an insert, a needle and a housing. The insert attaches to the dental tool and has a receiving portion. The needle has a passageway extending therethrough from a proximal end of the needle to a distal end of the needle. The passageway provides a single continuous flow path for delivering fluid from a reservoir at the proximal end of the needle to a root canal of a tooth at the distal end of the needle. The housing is molded over at least a portion of the needle and cooperates with the needle to maintain the needle in position relative to the receiving portion of the insert. The receiving section and the needle are coplanar. Energy generated by the ultrasonic energy generator is translated into movement of the needle, including the distal end of the needle which is planar to the longitudinal axis of the needle to provide optimum cleaning to the root canal.

Another aspect of the invention is directed to a consumable tip assembly for use with a dental tool. The dental tool has an ultrasonic energy generator positioned therein. The tip assembly has an insert, a needle and a housing. The insert attaches to the dental tool and has a needle receiving portion. The needle has a passageway extending therethrough from a proximal end of the needle to a distal end of the needle. The passageway provides a single continuous flow path for delivering fluid from a reservoir at the proximal end of the needle to a root canal of a tooth at the distal end of the needle. The housing is molded over at least a portion of the needle and cooperates with the needle to maintain the needle in position relative to the receiving portion of the insert. The housing has a fluid receiving projection in which the proximal end of the needle is positioned. The receiving section and the needle are coplanar. Energy generated by the ultrasonic energy generator is translated into movement of the needle, the movement of the needle being planar to the longitudinal axis of the needle to provide optimum cleaning to the root canal.

Another aspect of the invention is directed to a tip assembly for use with a dental tool. The dental tool has an energy generator positioned therein. Although this energy generator is usually an ultrasonic energy generator, other energy generators may be used, such as for example a sonic energy generator. The tip assembly has an insert and a needle. The insert attaches to the dental tool and has a needle receiving portion that accepts a needle. The needle has a passageway extending therethrough from a proximal end of the needle to a distal end of the needle. The passageway provides a single continuous flow path for delivering fluid from a reservoir at the proximal end of the needle to a root canal of a tooth at the distal end of the needle. The insert cooperates with the needle to transfer energy from the energy generator through the insert to the needle. The fluid has the energy imposed thereon as it passes through the needle.

The invention described herein has many advantages. The needle has a single continuous flow path which eliminates potential leak paths. As no joints or discontinuities are present, corrosion is limited. Inherent stress concentration locations are also eliminated, thereby allowing the tip assembly to be reliable during vibration. The configuration of the tip assembly guides and transfers the ultrasonic vibration and energy in the plane of motion, which provides proper agitation to the irrigants. The tip assembly is also disposable, thereby requiring that a new tip assembly be used for each patient and insuring that the tip assembly will be sterile prior to use.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a portion of a dental tool with a tip assembly attached to an ultrasonic wand thereof.

FIG. 2 is an enlarged perspective view of the tip assembly attached to the ultrasonic wand.

FIG. 3 is a diagrammatic view the tip assembly with the housing removed to illustrate a needle positioned in a slot of a threaded member.

FIG. 4 is a perspective view of the dental tool with the tubing extending from the tip assembly and cooperating with a guide attached to the ultrasonic wand.

FIG. 5 illustrates various views of the threaded insert of the tip assembly.

FIG. 6 illustrates various views of the needle of the tip assembly.

FIG. 7 illustrates various views of the assembled tip assembly.

FIG. 8 is a perspective view of the tip assembly attached to the ultrasonic wand and the tubing, the tubing having a connector attached to an end thereof.

FIG. 9 is a side view of the tip assembly shown in FIG. 8 with portions shown in cross-section.

FIG. 10 is an illustration of the movement of the needle as the ultrasonic wand is vibrated.

FIG. 11 illustrates the cleaning effectiveness of the tip assembly of the present invention compared to a needle of the prior art.

FIG. 12 is a perspective view of a first alternate embodiment of the tip assembly of the present invention.

FIG. 13 is a perspective view of an insert receiver of the tip assembly of FIG. 12.

FIG. 14 is a perspective view of a needle assembly of the tip assembly of FIG. 12.

FIG. 15 is a side view of a second alternate embodiment of the tip assembly of the present invention.

FIG. 16 illustrates various embodiments of the threaded insert of tip assembly of FIG. 15

FIG. 17 is a side view of a third alternate embodiment of the tip assembly of the present invention.

FIG. 18 is a perspective view of the tip assembly of FIG. 17.

FIG. 19 is a side view of a fourth alternate embodiment of the tip assembly, the tip assembly having separate flow paths for irrigation and aspiration.

FIG. 20 is a cross-section view taken along line A-A of the tip assembly of FIG. 19.

FIG. 21 is a cross-section view taken along line B-B of the tip assembly of FIG. 20.

FIG. 22 is a side view of a fifth alternate embodiment of the tip assembly of the present invention.

FIG. 23 is a side view of a sixth embodiment of the tip assembly of the present invention.

FIG. 24 is a side view of a seventh embodiment of the tip assembly of the present invention.

FIG. 25 depicts a side view of an eighth embodiment of the tip assembly of the present invention.

FIG. 26 depicts a side view of a ninth embodiment of the tip assembly of the present invention.

FIG. 27 depicts a tenth embodiment of the tip assembly of the present invention.

FIG. 28 depicts an eleventh embodiment of the tip assembly of the present invention.

FIG. 29 depicts a twelfth embodiment of the tip assembly of the present invention.

FIG. 30 depicts an optional embodiment for a needle of the present invention.

FIG. 31 provides several additional embodiments for needles that may be used in conjunction with the tip assembly of the present invention.

### DETAILED DESCRIPTION OF THE INVENTION

The practice of endodontics includes preparation of root canals to receive filler material. Such filler material is typical gutta percha but other comparable materials have been developed. It is important that the root canals be shaped and cleaned as thoroughly as possible to remove all organic material. Such organic material is typically pulpal material that exists as a natural portion of a tooth and by which a tooth is nourished during the formation process. Such pulpal material, if left within a root canal and entrapped by filler material, can become infected and thereby cause problems to the patient. The infection that originates within a root canal can spread to other parts of the body. For this reason, it is important, as above stated, to remove as much pulpal and other necrotic material from the confines of the root canals as is possible.

The typical endodontic procedure requires the endodontist to scrape and shape the root canals in a way to remove as much as possible of pulpal material and to shape the root canal to receive filler material. However, root canals typically have laterally extending fissures and other irregularities in which pulpal material can become entrapped, thereby making it very difficult to remove all pulpal material by physically scraping and shaping alone. For this reason, a procedure has arisen wherein after the physical scraping and shaping occurs, a root canal is irrigated or flushed with an irrigant or solution to remove and/or neutralize the organic pulpal material that would otherwise remain.

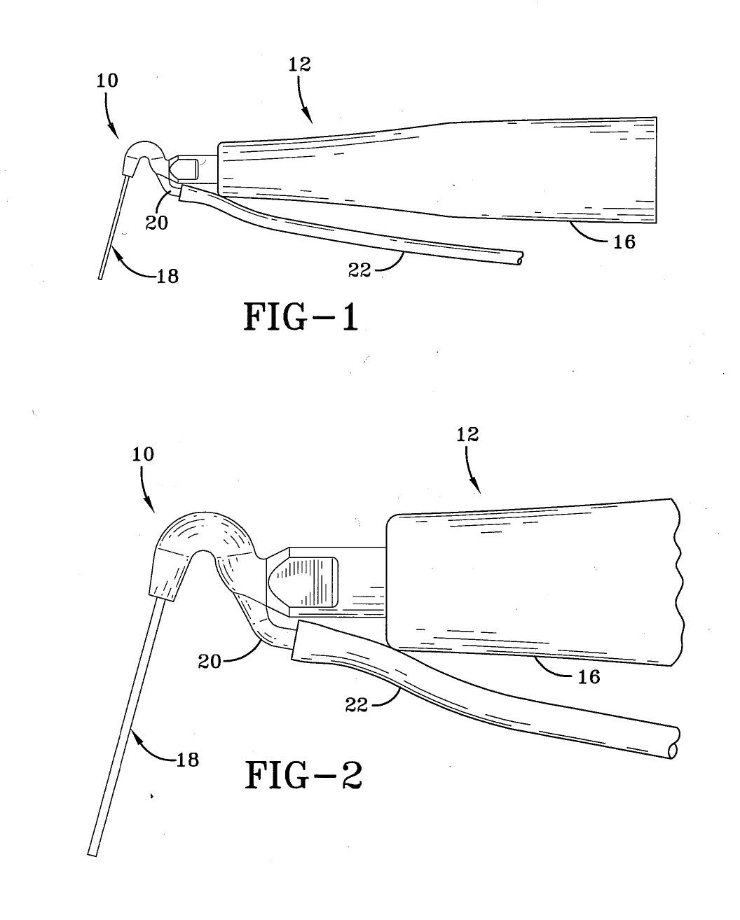

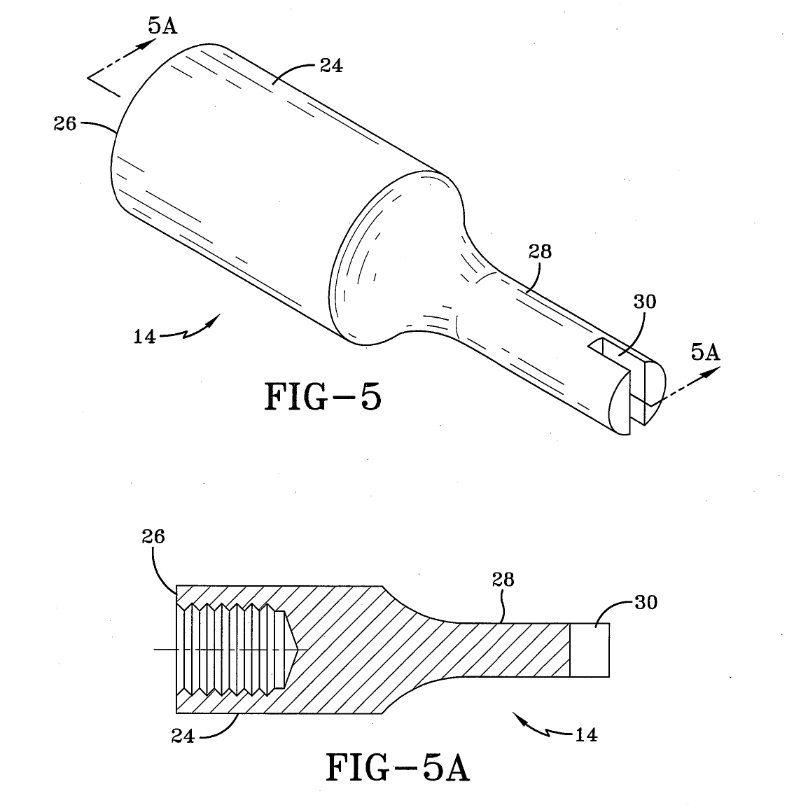

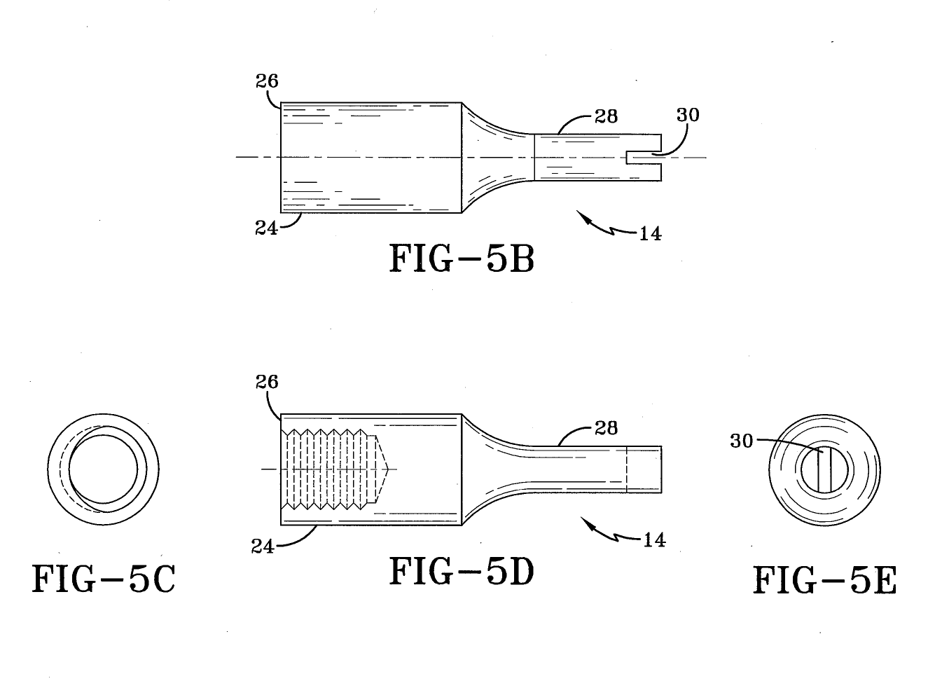

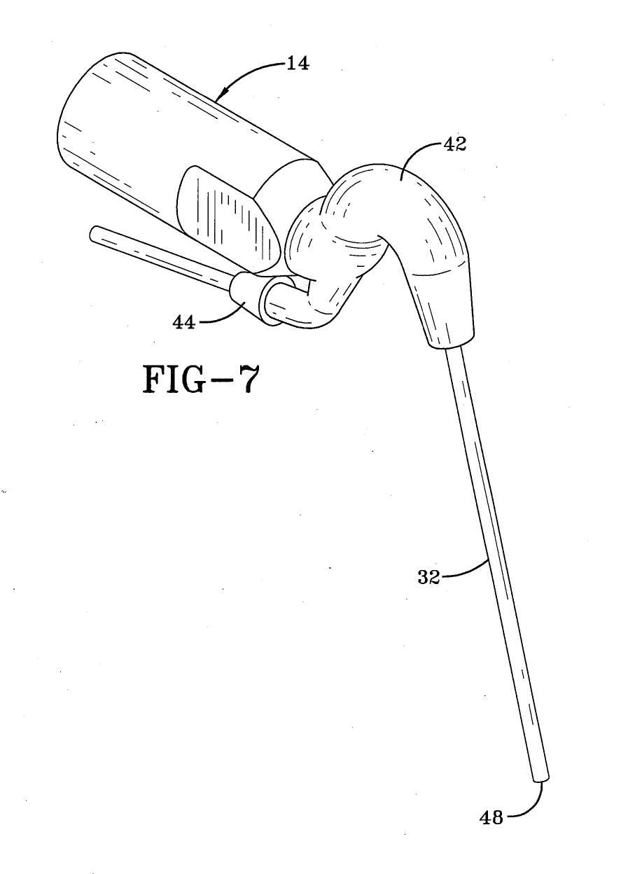

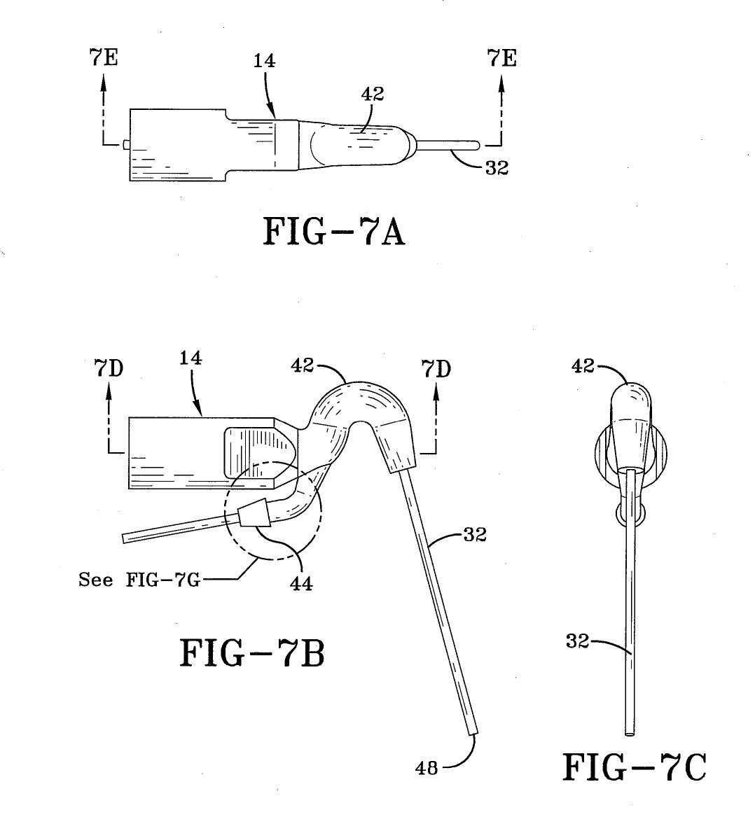

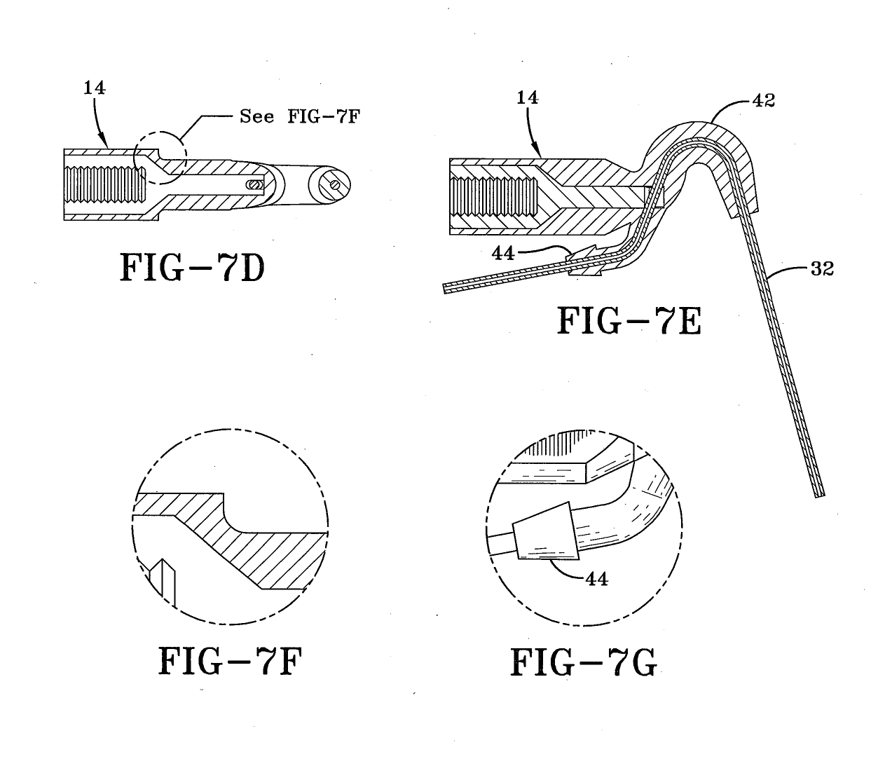

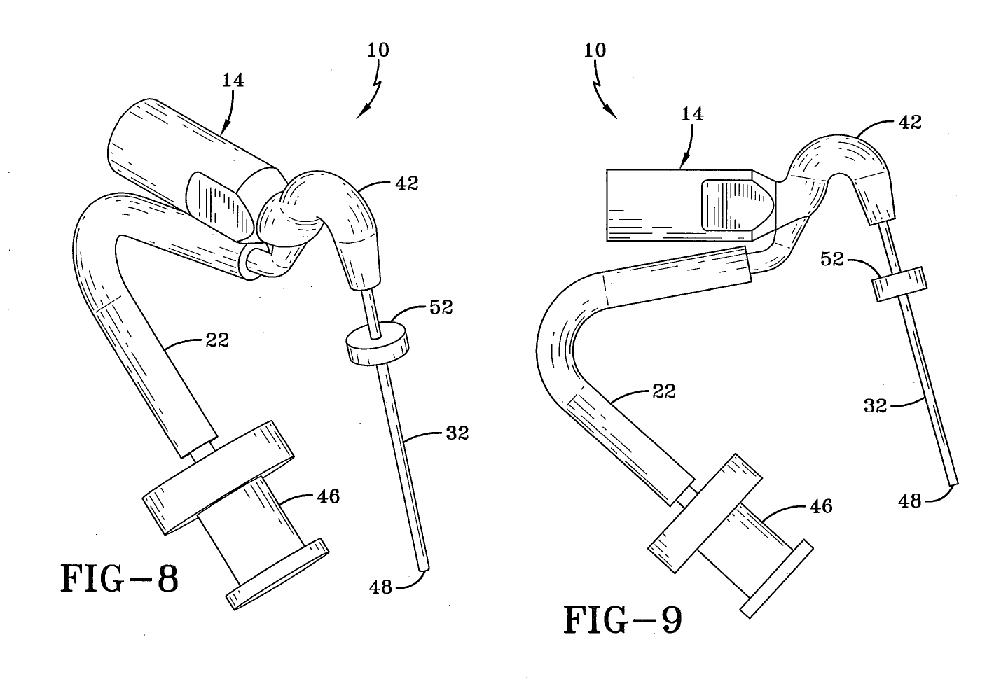

With reference to FIGS. 1 through 9, and according to an exemplary embodiment of the present invention, a consumable tip assembly 10 for use with a dental device 12 includes a threaded insert 14 for cooperating with a wand 16, a hypodermic needle 18 which engages the threaded insert 14 and a tube-receiving projection 20 from which tubing 22 extends. The dental device 12 has a wand 16, which is a graspable and manipulatable hand piece. The wand 16 has a proximal end 17 in communication with the tip assembly 10. In a preferred embodiment, the wand includes an ultrasonic energy generator or transducer (not shown) positioned in the wand 16 proximate the proximal end 17.

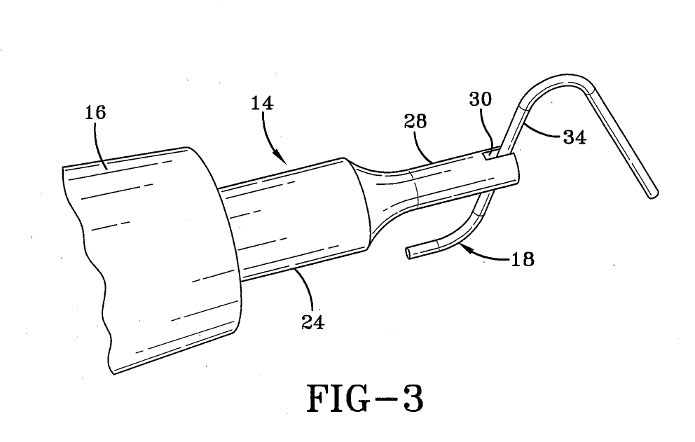

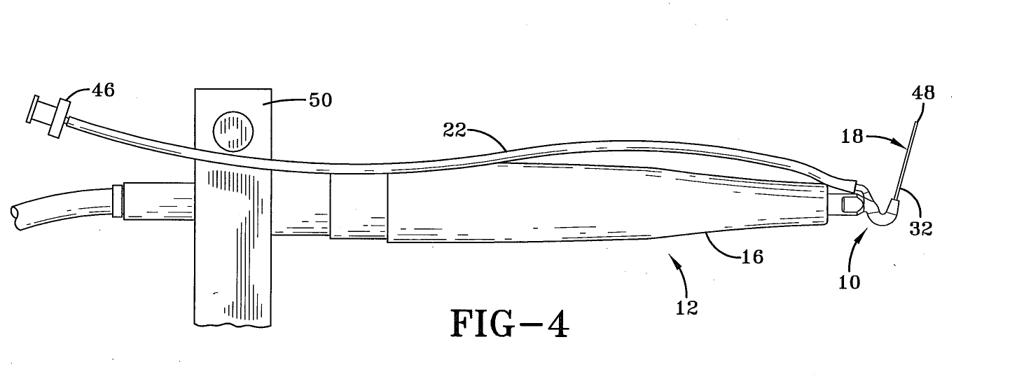

As best illustrated in FIGS. 3, 5, 6, 7, 8 and 9, threaded insert 14 includes a threaded housing 24 with a first planar surface 26 which is threadably attached to the ultrasonic wand 16 when the dental device 12 is in operation. A needle positioning member 28 extends from the threaded housing 24 in a direction away from the first planar surface 26. A needle receiving portion or slot 30 is positioned at the end of the needle positioning member 28. The threaded housing 24 and the first planar surface 26 are compatible with many commercially available tools. The threaded insert 14 may be made from brass, aluminum, low carbon steel, or other metals and/or alloys which have the strength and stability characteristics to mount the ultrasonic wand 16 and withstand the vibration applied thereto.

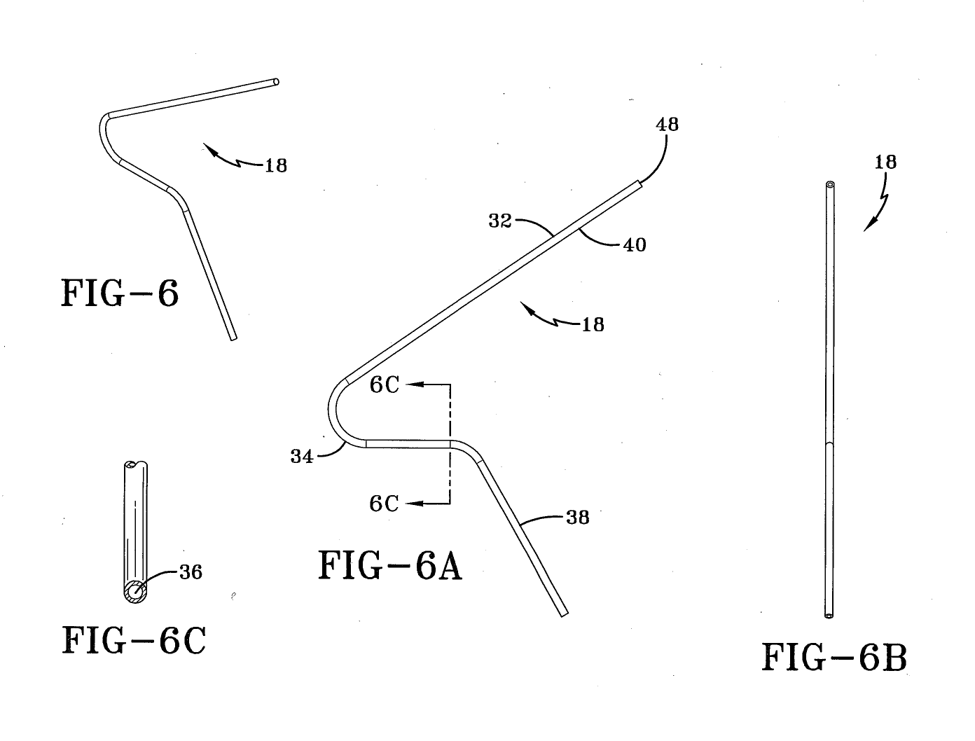

Referring to FIGS. 3 and 6, the hypodermic needle 18 preferably is made from stainless steel and is formed to have a generally straight portion 32 and a generally S-shaped or arcuate portion 34 which is integral with the straight portion 32. The needle 18 has a passageway 36 which extends through the entire length of the needle 18 from its proximal end 38 to its distal end 40. The pathway provides a single continuous, uninterrupted flow path for irrigants, as will be more fully described. A portion of the needle 18 is positioned and maintained in the needle receiving slot 30 of the needle positioning member 28 of the threaded insert 14.

In the embodiment shown, the needle is made from 25 gage stainless steel, although other gage needles and materials can be used as well. The end of the needle between the tip 48 and the stopper 52 preferably is approximately 1½ inches in length. The tip 48 is blunt, but may include a bevel of about 15° . Preferably, needle 18 is substantially rigid, i.e., non-flexible. Other needle configurations can be used without departing from the scope of the invention. Tubing 22 may have an inside dimension of 1/16 inch and may be manufactured from plastic or a similar material, as a syringe, although other materials are compatible with these components of the present invention.

The stopper 52 is a known endodontic stopper which is placed on the needle 18 for judging the depth of penetration of the tip 48 of the needle 18 into the root canal. The stopper 52 is set to prevent the tip 48 from penetrating the apex of the root canal. The stopper 52 may be made from plastic or other materials.

A housing 42 is over molded over the threaded insert 14 and a portion of the needle 18, as best shown in FIGS. 1, 2 and 7 through 9. The tube receiving projection 20 is formed in the housing 42 proximate the proximal end 38 of the needle 18. The tube receiving projection 20 has a circumferentially extending barb 44 which cooperates with the tubing 22 to maintain the tubing in position on the tube receiving projection 20. In the embodiment shown, the housing 42 is injection molded using polycarbonate material. However, other plastics or materials which have strength and hardness characteristics to maintain the needle 18 in position relative to the threaded insert 14 as the tip assembly 10 is vibrated can be used.

Tubing 22 is used to deliver fluid from a reservoir to the needle 18 to a site within a dental patient's mouth where flushing is to occur. A connector 46, positioned at the end of the tubing 22 which is removed from the barb 44, is attached to a fluid reservoir such as a syringe. As shown in FIGS. 4, 8 and 9, a syringe having a Luer-Lok type connector may be used as the reservoir for fluids because the operator of dental device 12 can easily control the volume of fluid delivered into and through tubing assembly 32. Other types of reservoirs include any type of container which can store the irrigant. Some reservoirs may require the use of a pump to move the irrigants from the reservoir to the tubing 22, while others do not require a pump. The tubing may also have various configurations, including but not limited to a spout from a bladder or the like or an fluid line which is positioned internally to the ultrasonic wand 16. Depending on the configuration of the tubing, the tubing may be made from plastic, rubber, metal or other know materials for tubing.

Prior to use, the tip assembly 10 must be properly assembled onto the ultrasonic device 16. An exemplary method for assembling tip assembly 10 includes the following steps. First, threaded insert 14 is threaded onto ultrasonic wand 16. As will be appreciated by those skilled in the art, ultrasonic wand 16 is typically attached to a separate power supply and may be any of a variety of ultrasonic devices that are commercially available. One end of tubing 22 is attached to the tube receiving projection 20 and the other end of the tubing assembly is attached, to a syringe or other reservoir. A portion of the tubing may be secured to ultrasonic wand 16 by guide 50 as shown in FIG. 4. The guide 50 may act as a strain relief for the tubing 22 and helps to keep the tubing 22 close to the ultrasonic wand 16, thereby preventing entanglements and kinks in the tubing 22.

Once the tip assembly 10 has been assembled to the ultrasonic wand 16 and tubing 22, a portion of needle 18 is placed within the root canal in tooth to an appropriate length in which the tip 48 of the needle 18 does not penetrate the apex of the root canal. The ultrasonic wand 16 is activated by the user at a power level ranging from low to the maximum power. Ultrasonic energy passes from the ultrasonic wand 16 through the threaded insert 14 and to the needle 18. The curved, double-ended configuration of the needle 18 acts similarly to a tuning fork. The vibrations induced on the center of the needle 18 by the threaded insert 14 are amplified due to the free vibration at tip 48. The fluid is then pumped or forced through the passageway 36 of the needle 18 to the root canal. The flow of fluid can begin prior to, simultaneously with or after the ultrasonic wand 16 has been activated.

The vibrations of the ultrasonic wand 12 are most effective when they are translated to the tip 48 in a single plane. The shape of the needle 18 and the needle-receiving slot 30 creates a geometry that generates movement of the needle 18 and its tip 48 in a direction which is planar to the longitudinal axis of the needle 18. This planar motion is maintained over cycles, as the over-molded housing 42 maintains the needle 18 within the needle-receiving slot 30 of the threaded insert 14, thereby allowing the motion of the ultrasonic wand 16 to be properly transferred to the needle 18 without distortion.

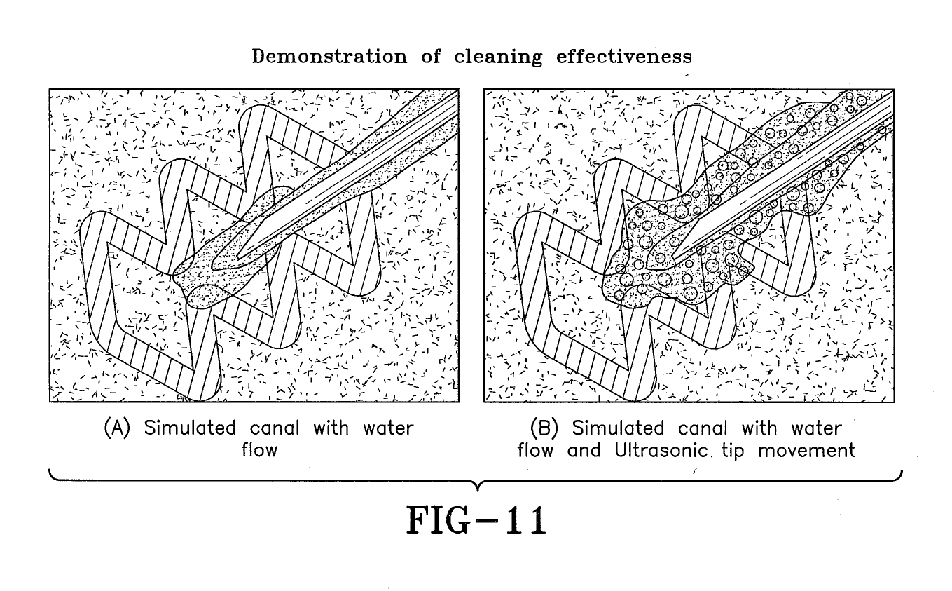

As is illustrated in FIG. 11, as ultrasonic energy is directed through the needle 18 and into the root canal, the needle 18 activates the solution, i.e., a fluctuating pressure-vacuum field known as transient and stable cavitation is generated. The use of the ultrasonic energy allows the irrigant to be delivered to the root canal at a relatively low stream velocity. As will be appreciated by those skilled in the art, this energy field destroys microorganisms present within the root canal and loosens tissue and other debris from the affected area, thereby allowing for a more complete endodontic treatment.

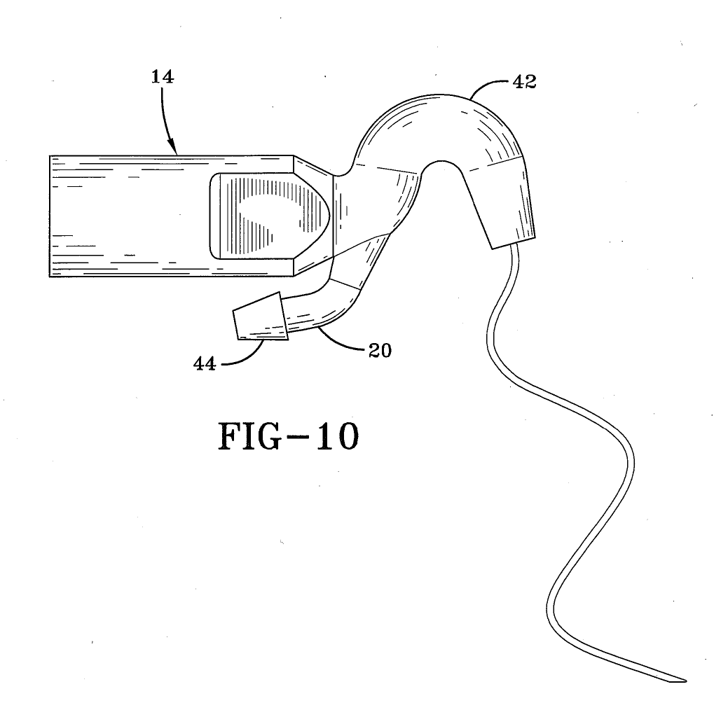

In the embodiment described, the needle 18 oscillates at approximately 27 kHz, which allows the needle 18 to vibrate at resonant frequency (as illustrated in FIG. 10), thereby providing optimum energy to the irrigant to provide optimum cleaning. The resonant frequency of various needles can vary, but can be calculated, using the length of the needle, the stiffness of the materials and the assembly, and the geometry of the tip assembly. Generally the frequency is above 20 kHz.

As the needle is operating in ultrasonic mode, an irrigant or irrigating solution, stored in the syringe or other reservoir, is dispensed into the root canal by depressing the plunger on the syringe or by actuating a pump if another type of reservoir is being used. This solution washes out the affected area within the root canal and effectively removes loosened tissue, microorganisms, and other debris. By way of example, a typical solution is a diluted sodium hypochlorite, but other solutions such as sterile saline, citric acid, calcium hydroxide, antibiotic solutions, antiseptic solutions, demineralizing solutions or a combination of these solutions may be used as irrigating solutions with the present invention. Additionally, the present invention is useful for placing the following materials in the root canal space: endodontic medications and medicaments such as calcium hydroxide, camphorated paramonochlorphenol, formocresol, and camphorated phenol; endodontic sealers such as zinc oxide, calcium hydroxide and resin; and endodontic obturation materials such as gutta percha, and zinc oxide.

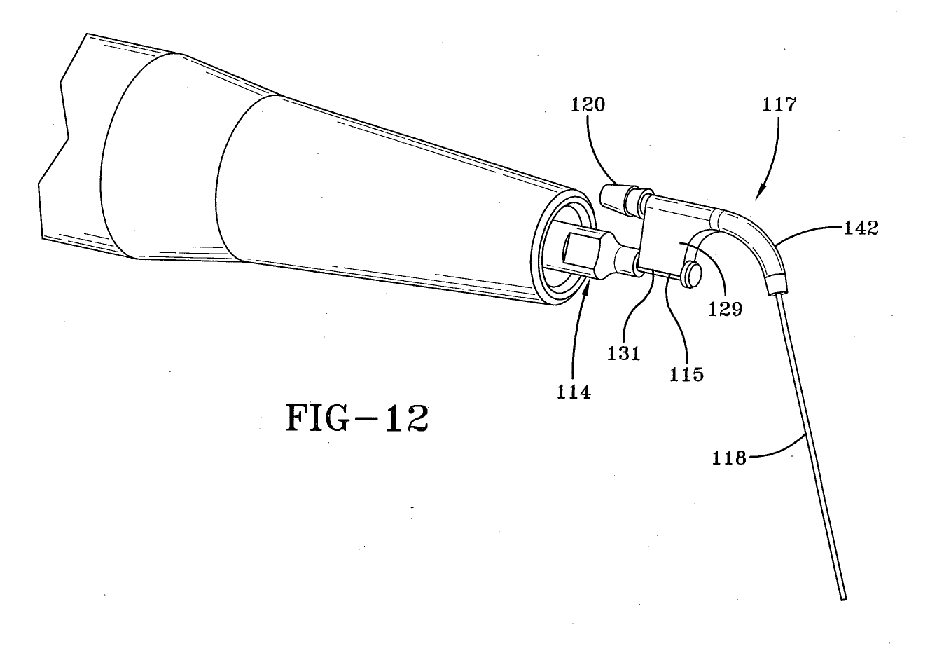

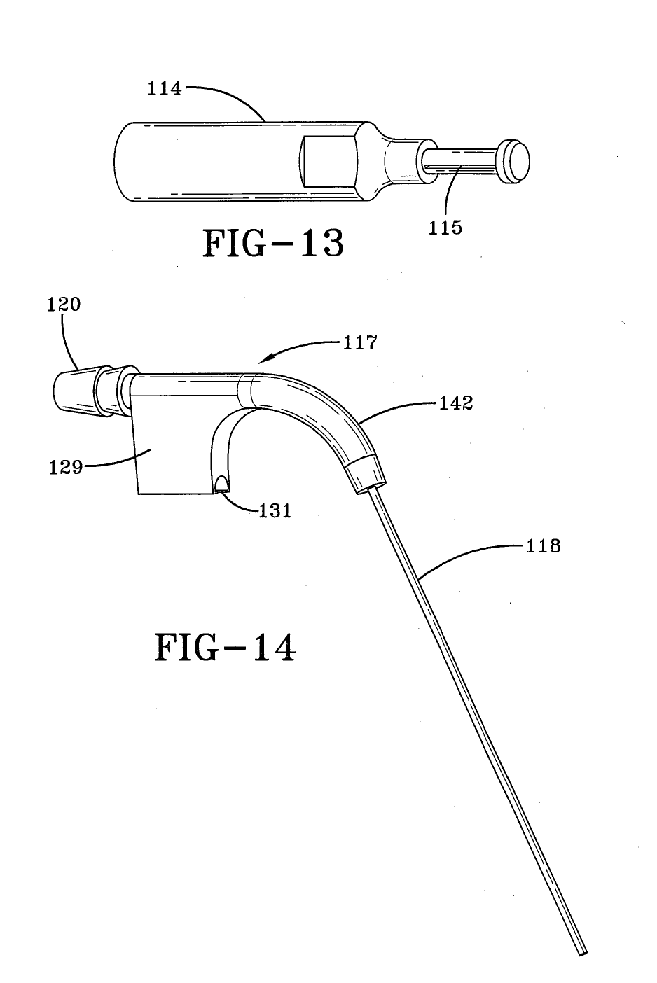

FIGS. 12 through 14 show a first alternate embodiment of the tip assembly 110. In this embodiment, the threaded insert 114 has a needle assembly receiving slot 115. A needle assembly 117 has a needle 118 with a housing 142 molded over a proximate end of the needle 118. The housing 142 has the tube receiving projection 120 which extends therefrom. A threaded insert mounting projection 129 extends from the housing and has a slot receiving recess 131 provided at the end thereof. The slot receiving recess 131 is positioned in the receiving slot 115 of the threaded inserted 114 to properly mount the needle assembly 117 to the threaded insert 114. The housing is made of a material which will properly translate the motion of the threaded insert 114 to the needle 118 without distortion.

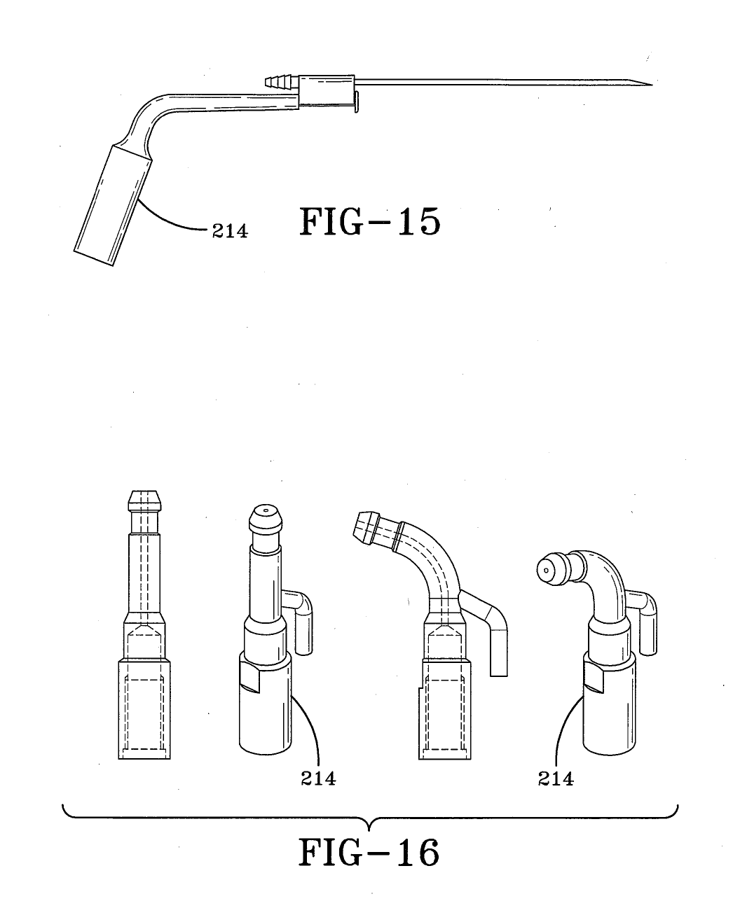

FIGS. 15 and 16 illustrate a second alternate embodiment of the tip assembly. While the shape of the threaded insert 214 can vary, as shown in the FIGS., the operation of the second alternate embodiment is similar to that of the first alternate embodiment.

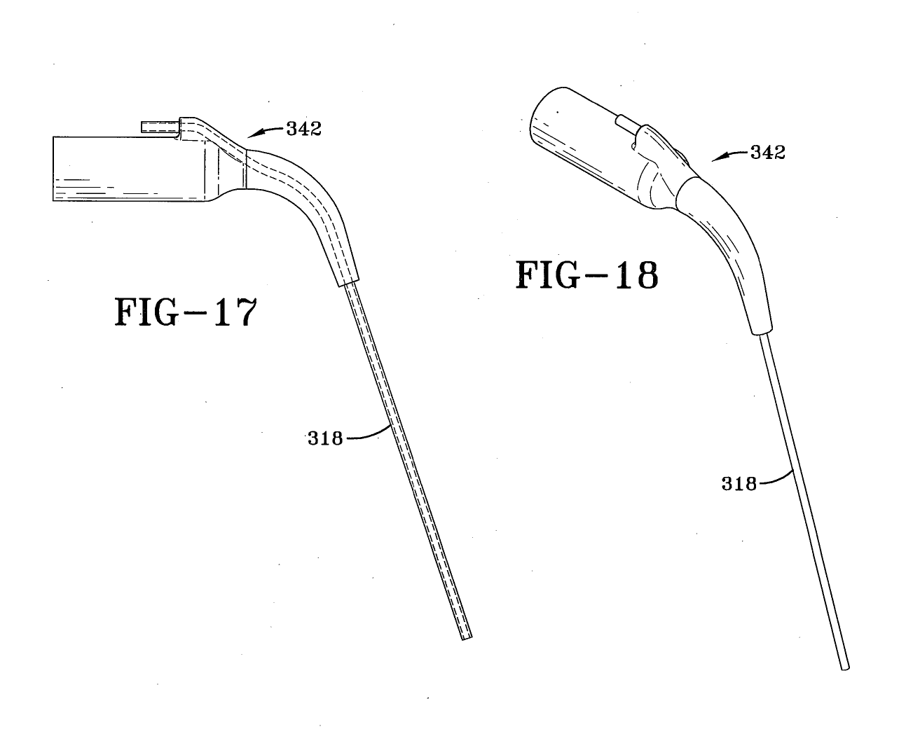

FIGS. 17 and 18 illustrate a third alternate embodiment of the tip assembly. In this embodiment the molded housing 342 incorporated the function of the threaded insert therein. The needle 318, while having a different shape to that previously described, extends through the housing to engage the appropriate tubing. The housing 318 is made of a material which will properly translate the motion of the ultrasonic wand to the needle 318 without distortion.

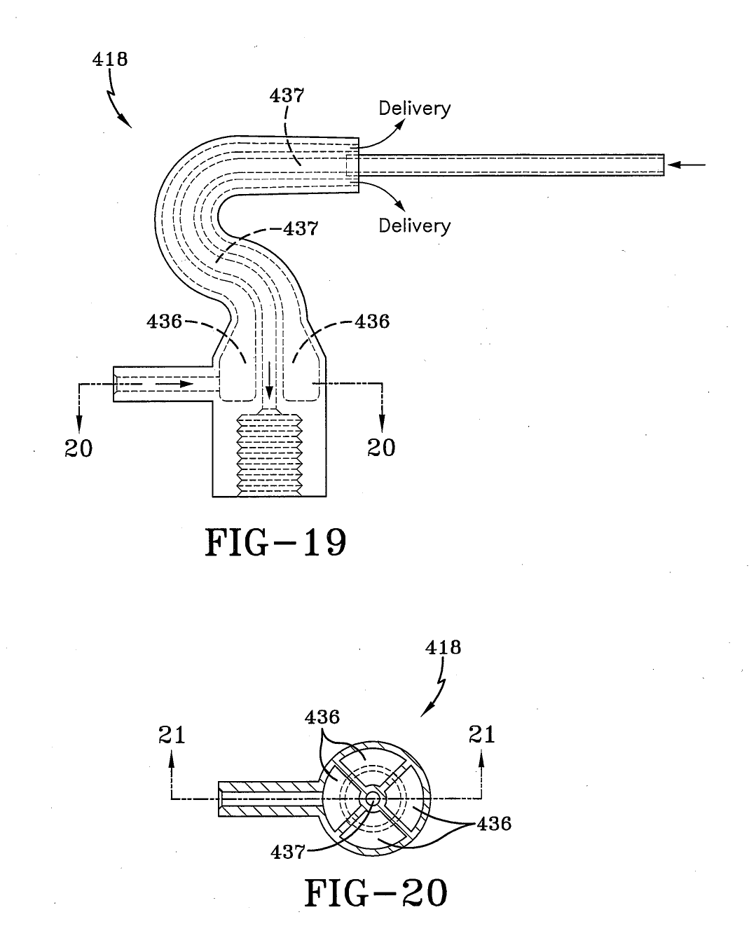

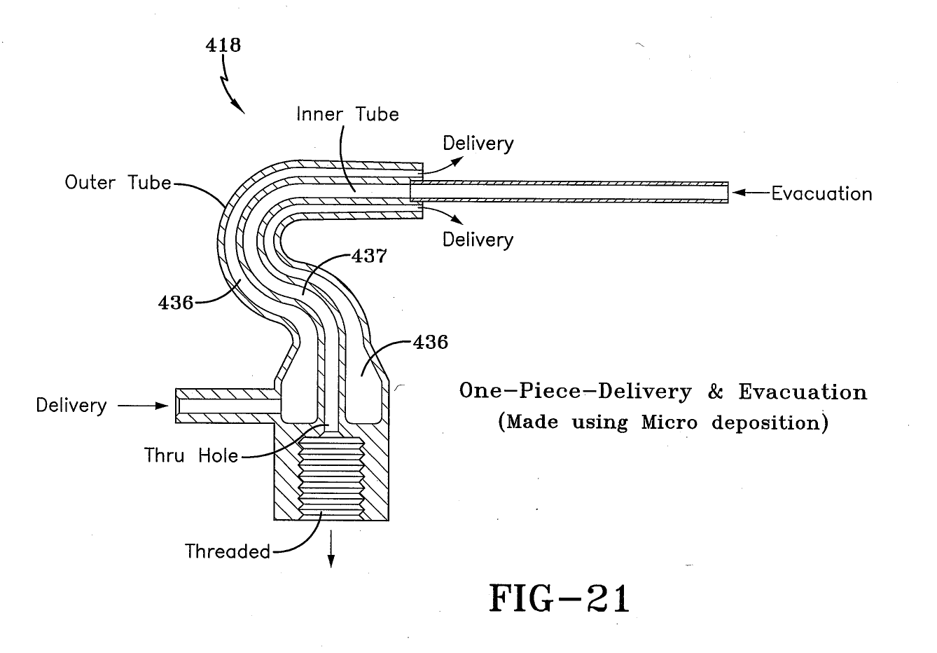

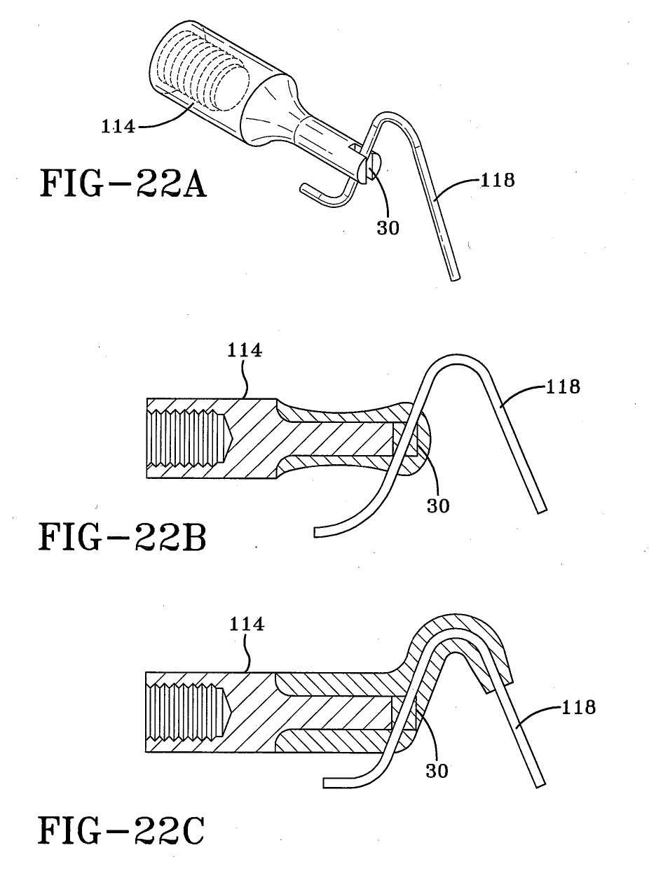

FIGS. 19 through 21 illustrate a fourth alternate embodiment of the tip assembly. In this embodiment, the housing 418 has irrigation passageways 436 which deliver the irrigant to the root canal. In addition aspiration passageways 437 are provided to remove the irrigant. In the embodiment shown, one aspiration passageway 437 is provided at the center, with the irrigation passageways 436 being positioned circumferentially therearound. However, the respective positions of the passageways can be reversed or altered and the number of passageways can be changed without departing from the scope of the invention.

FIG. 22 depicts a fifth alternate embodiment of the tip assembly 110. In this embodiment, as shown in FIG. 22(a) the threaded insert 114 includes a needle receiving slot 30. A portion of the needle 118 is positioned in needle receiving slot 30. The needle is then permanently affixed within needle receiving slot by welding, soldering or brazing. Permanent affixation may be accomplished by bonding the needle 118 in needle receiving slot 30 with an adhesive. Affixation may also be accomplished by crimping the needle 118 within needle receiving slot 30 as long as the crimping operation does not adversely affect the passageway within needle 118. After the needle 118 has been affixed within slot 30, a material may be overmolded around the insert 114, the needle 118, and the needle receiving slot 30 as shown in FIG. 22(b). Over molding that encompasses the S-bend portion of needle and includes a small segment of the straight section of needle 118 may also be accomplished as depicted in FIG. 22(c).

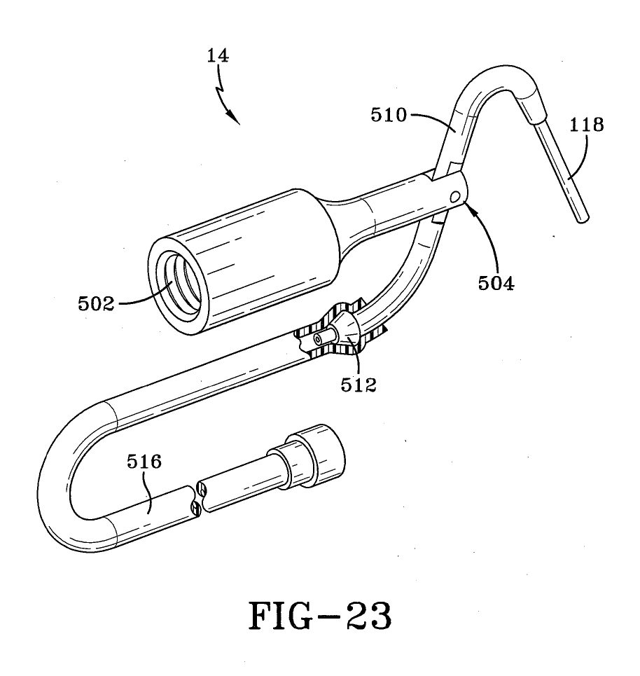

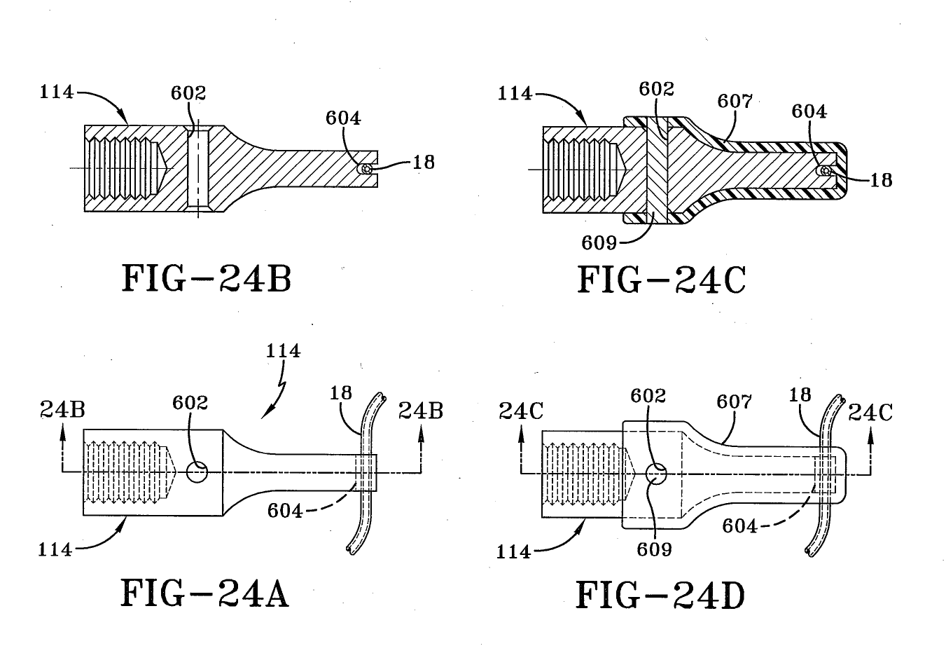

FIG. 23 depicts a sixth embodiment of the tip assembly of the present invention. In this embodiment, threaded insert 14 is not provided as a consumable. Threaded insert 14 includes a threaded end 502 for threadable attachment to the ultrasonic wand 16 as previously discussed. However, threaded insert 14 includes a quick connect/disconnect 504 opposite the threaded end. The needle 118 includes an overmolded portion or stiffened metal portion 510 that can be inserted into the quick connect/ disconnect. A barbed portion 512 is included at the proximal and of the needle 118 for attachment of plastic tubing 516 that extends to a fluid source. Needle 118 provided with either an overmolded portion or stiffened metal portion 510 is provided as a separate item, since it is a consumable.

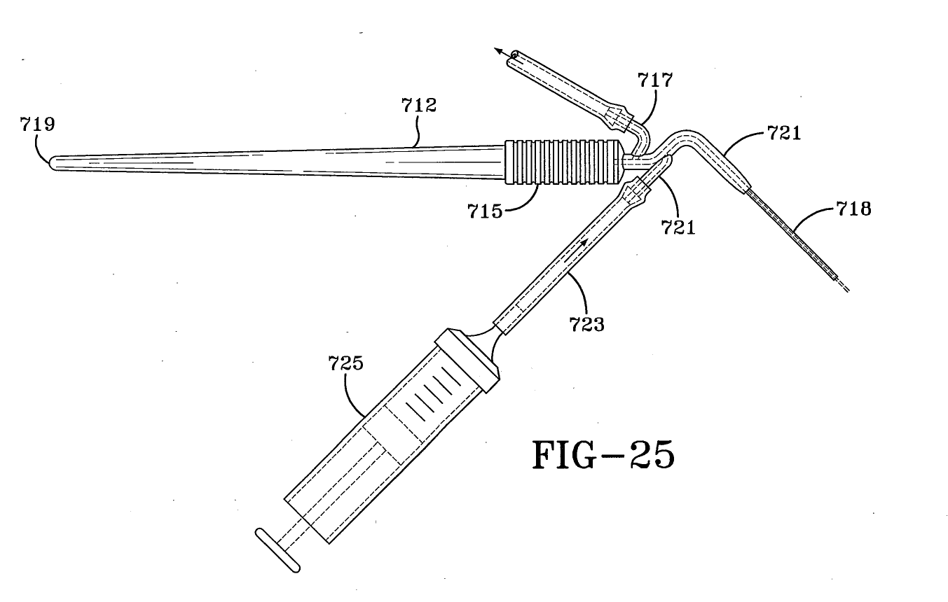

FIG. 24 depicts a seventh embodiment of the tip assembly of the present invention. FIGS. 24a and b depict cross-sections of the threaded insert at 90° . As can be seen in FIG. 24a, two apertures extend through the threaded insert 114, a first aperture 602 positioned near the proximal end, and a second aperture 604 positioned near the distal end. Second aperture 604 accepts needle 118. A cap 607, which is disposable, snaps over threaded insert 114 as depicted in FIG. 24c. FIG. 23d depicts the tip assembly of FIG. 23c rotated 90° . Cap 607 captures and retains needle 118. Cap 607 is retained within first aperture 602 by either a pin 609 or by extensions(nubs) (not shown) extending from cap 607 and molded as integral with cap 607, thereby retaining cap in place. Cap 607 is easily replaceable by unsnapping or by pin removal.

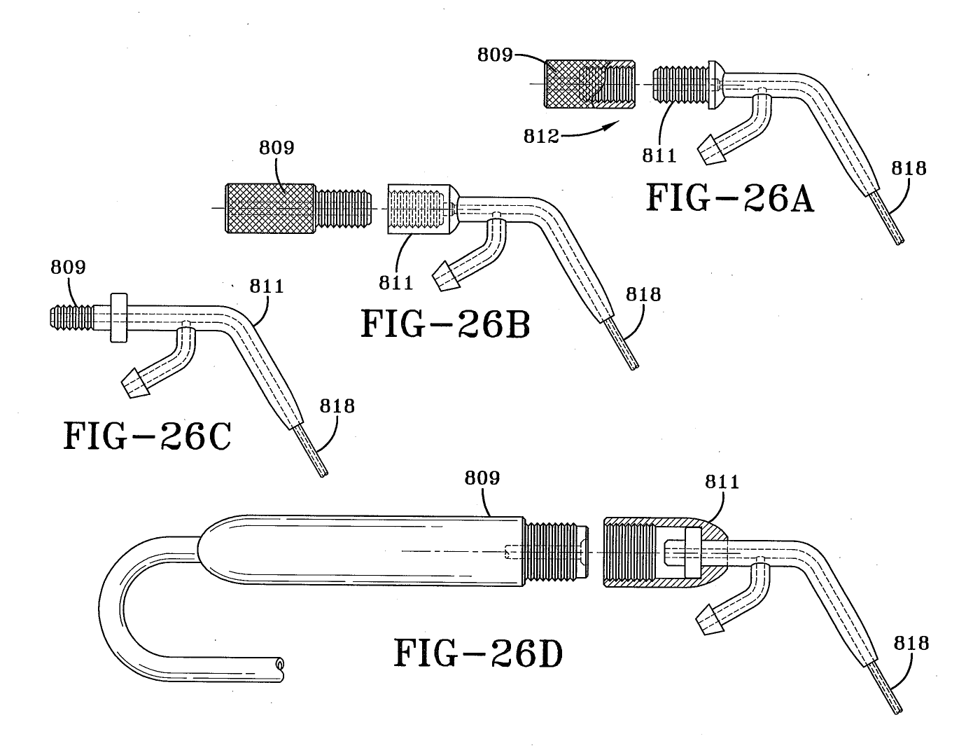

FIG. 25 depicts a side view of an eighth embodiment of the tip assembly of the present invention. In this embodiment, an ultrasonic wand 712 includes an inner cavity that receives a magnetostrictive insert. The ultrasonic wand further includes a standard insert grip point 715 as well as an external water outlet 717 and an external water inlet 719. The inlet and outlet can be connected to provide a flow of water that cools the magnetostrictive insert. Attached to the distal end of the wand includes a needle 718 having a central aperture in communication with a second aperture in wand 712. The distal end of needle 718 provides irrigant or bleach to the work area. The opposite end 723 is connected to a syringe or pump mechanism 725 that is the source of irrigant with bleach.

FIG. 26 depicts a side view of a ninth embodiment of the tip assembly of the present invention. In this embodiment, wand 812 is comprised of two separate components 809, 811 threaded to one another. Component 809 includes a grip for the dental professional and houses the energy source, typically a sonic or an ultrasonic transducer. Component 811 is adaptable to receive a tip or needle 818 which can provide an irrigant to the work area. Tip or needle 818 may be integral with component 811 or may be a separate piece. Wand 812 can be configured so that component 809 includes the female threads that receive corresponding male threads on component 811 as shown in FIG. 26(a). Alternatively component 809 may include male threads that are threaded to corresponding female threads of component 811, as depicted in FIG. 26(b). However, any custom threading arrangement may be used to join component 809 to component 811, as depicted in FIG. 26(c). One complete example is depicted in FIG. 26(d).

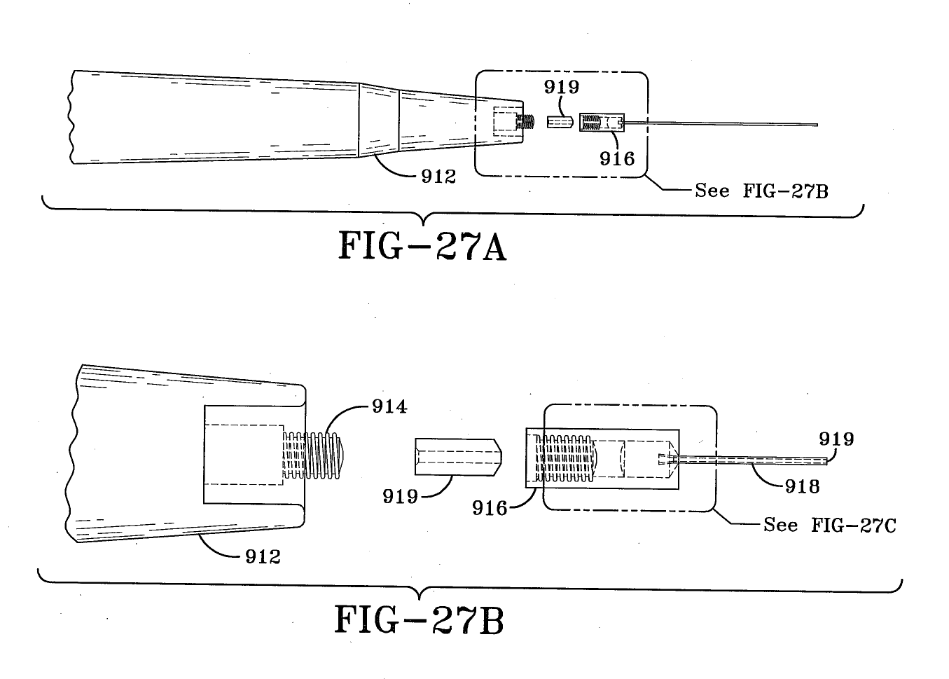

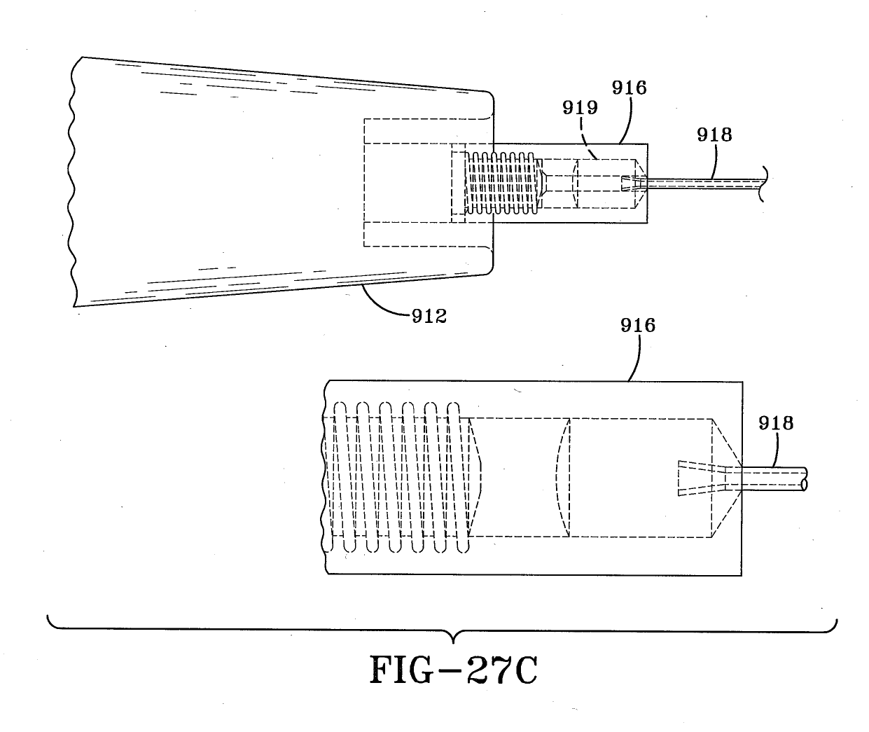

FIG. 27 depicts a tenth embodiment of the tip assembly of the present invention. In this embodiment, the handpiece 910 comprises a wand portion 912 having a threaded distal end 914, a threaded coupler 916 that receives a needle 918 having a central aperture 919. Intermediate between wand portion 912 and threaded coupler 916 is a slip that insert spacer 919. An exploded view is depict in FIG. 27(a). A magnified exploded view is depicted in FIG. 27(b). The assembly is depicted in FIG. 27(c). When the threaded distal end 914 of wand portion 912 is assembled to threaded coupler 916 with insert spacer 919 captured between threaded coupler and wand portion, a continuous aperture extends through wand portion 912, slip fit insert spacer 919, threaded coupler 916 to aperture 919 of needle 918. Needle 918 may be integral with the threaded coupler 916, or it may be provided as a separate component. Slip fit insert spacer 919, threaded coupler 916, and the needle 918 are removed and may be provided as disposable items or may be autoclaved as desired.

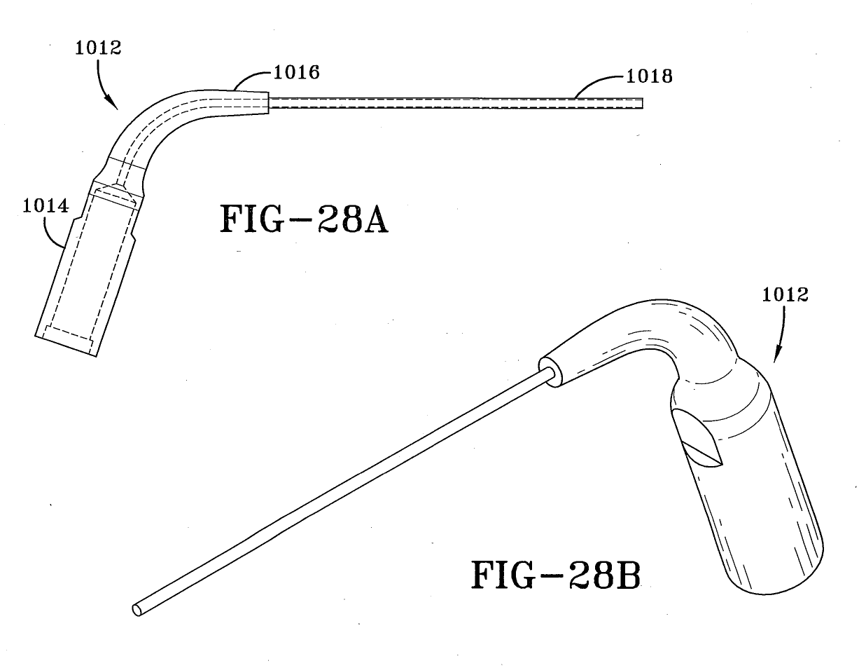

FIG. 28 depicts an eleventh embodiment of the tip assembly of the present invention. This embodiment depicts a wand 1012 having a main body 1014 and a needle portion 1018. The needle portion 1018 extends at an angle from the main body 1014. As depicted in FIG. 28, wand 1012 is angled so that a distal portion 1016 extends at an angle, preferably at an angle of 90° or less, from the proximal portion 1014. The needle portion 1018 extends in a substantially straight line from distal portion 1016 of wand 1012. Wand 1012 may house an energy source, such as an ultrasonic or magnetostrictive element, and needle portion 1018 can be provided as disposable unit. In an alternative embodiment, not shown in FIG. 28, needle portion 1018 may be curved at an angle of 90° or less, while main body 1014, and distal portion of wand 1016 have a single central axis and accepts angled needle portion 1018 in distal portion of wand, so that the combination of wand 1012 and needle 1018 provide a tip assembly having a wand 1012 comprising a main body 1014 that can be gripped by a dental professional, and a needle portion 1018 that extends at an angle of 90° or less from the portion gripped by the dental professional.

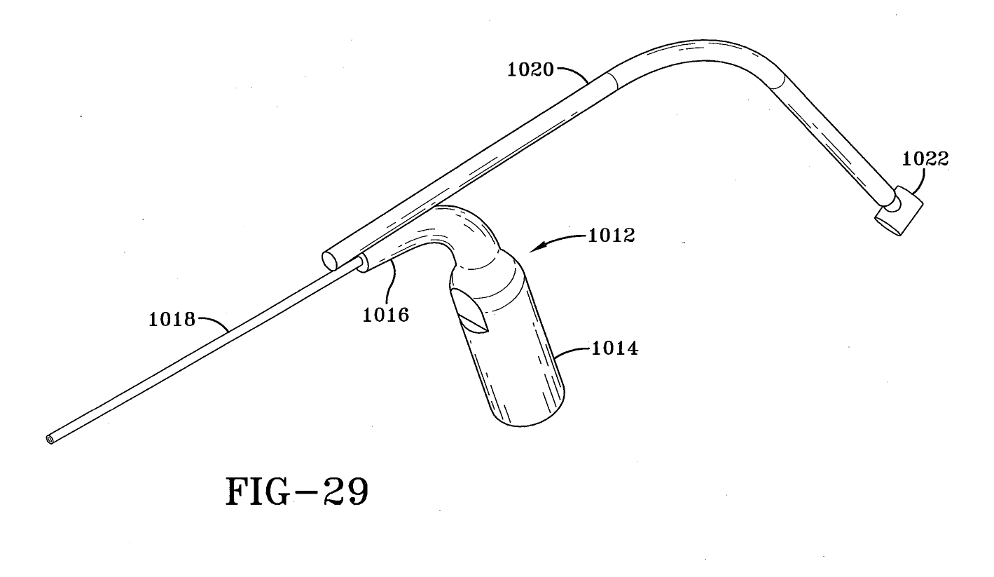

FIG. 29 depicts a twelfth embodiment of the tip assembly of the present invention. In this embodiment, wand 1012 is angled so that a distal portion 1016 of wand and 12 extends at an angle, preferably at an angle of 90° or less from a proximal portion of wand 1014. Needle portion 1018 extends from the distal portion 1016 of the wand, and needle portion 1018 may be solid. A fluid delivery tube 1020 is bonded or attached externally to the distal portion 1016 or to needle portion 1018. The fluid is directed through tube 1020 to the distal end of the needle portion 1018 to the work area in the root canal from a reservoir of fluid located at the proximal end 1022 of the tube 1020. Fluid may be provided to tube 1020 using a syringe or a pump.

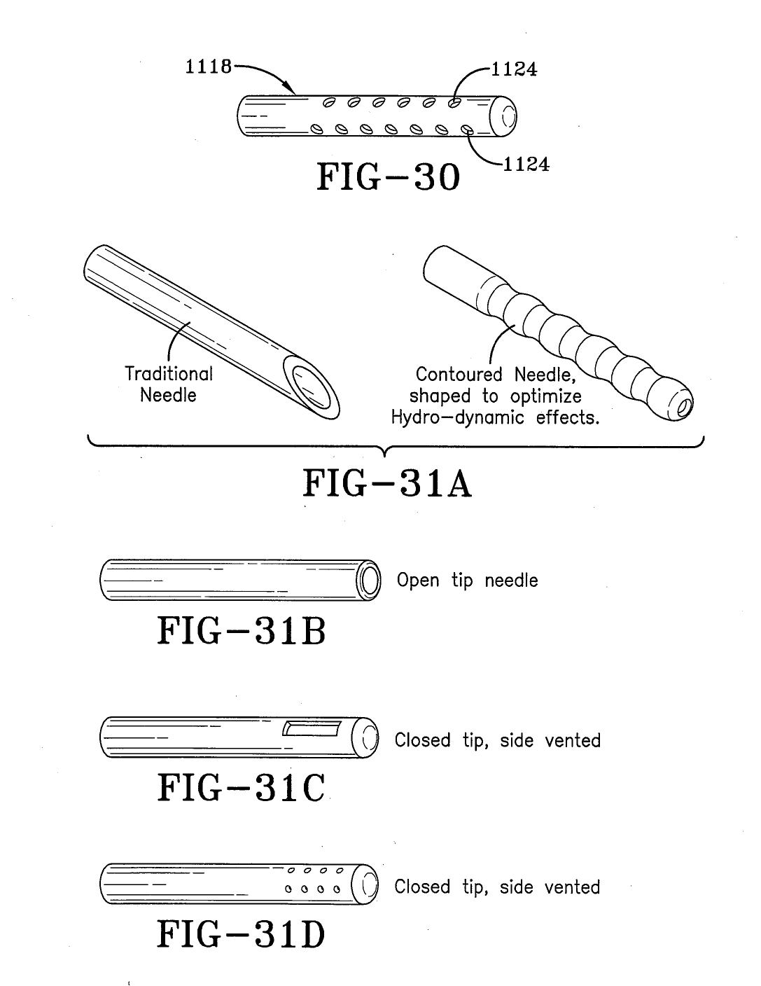

FIG. 30 depicts an optional embodiment for a needle of the present invention. In a preferred embodiment, this needle 1118 includes a central axis extending in a longitudinal direction along the needle. The needle has a central aperture extending in the longitudinal direction. Stated differently, needle 1118 is hollow. However needle 1118 includes a plurality of apertures extending through the circumference at an angle to the central axis. As depicted in FIG. 30, the plurality of apertures extend through the circumference at a right angle to the central axis. However, the apertures' direction is not so limited as they may extend through the circumference of the needle at any convenient angle to the central axis. Furthermore, the needle 1118 may include an aperture along the central axis at its most distal end. The plurality of apertures provide the needle with the ability to deliver fluid to the work area, typically the root canal region, omni directionally.

FIG. 31 provides several additional embodiments for needles that may be used in conjunction with the tip assembly of the present invention. FIG. 31(a) depicts a traditional straight, solid needle. FIG. 31(b) depicts a straight, hollow needle having an open end at the tip or distal end of the needle. FIG. 31(c) depicts a hollow needle with the tip end closed, but having a circumferential side-vented opening to direct fluid into the cavity in an axial direction. FIG. 31(d) depicts a hollow needle with the tip end closed but having a plurality of openings along the circumference to direct fluid axially substantially 360° around the circumference of the needle. Apertures for needles depicted in FIGS. (c) and (d) can be fabricated using laser cutting techniques. FIG. (e) depicts a shaped or comport needle that can be used to magnify the hydrodynamic effects of the fluids flowing through it. Any of these needle designs can be used with or as part of the tip assembly of the present invention.

The invention described herein has many advantages. The needle has a single continuous flow path which eliminates potential leak paths. As no joints or discontinuities are present, corrosion is limited. Inherent stress concentration locations are also eliminated, thereby allowing the tip assembly to be reliable during vibration. The configuration of the tip assembly guides and transfers the ultrasonic vibration and energy in the plane of motion, which provides proper agitation to the irrigants. The tip assembly is also disposable, thereby requiring that a new tip assembly be used for each patient and insuring that the tip assembly will be sterile prior to use.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A tip assembly for use with a dental tool which has an ultrasonic energy generator positioned therein, the tip assembly comprising:
an insert for attaching to the dental tool, the insert having a receiving portion;
a needle having a passageway extending therethrough from a proximal end of the needle to a distal end of the needle, the passageway providing a single continuous flow path for delivering fluid from a reservoir at the proximal end of the needle to a root canal of a tooth at the distal end of the needle;
a housing molded over at least a portion of the needle, the housing cooperating with the needle to maintain the needle in position relative to the receiving portion of the insert;
the receiving portion and the needle are planar;
whereby the energy generated by the ultrasonic energy generator is translated into movement of the needle and the distal end of the needle which are planar to a longitudinal axis of the needle to provide optimum cleaning to the root canal.

2. The tip assembly as recited in claim 1 wherein the insert includes a threaded housing having a first planar surface which can be threadably attached to the dental tool, a needle positioning member extending from the threaded housing in a direction away from the first planar surface, the receiving portion positioned at the end of the needle positioning member.

3. The tip assembly as recited in claim 2 wherein the needle has a straight portion and a S-shaped portion, the S-shaped portion cooperates with the receiving portion of the insert.

4. The tip assembly as recited in claim 2 wherein the receiving portion has a needle receiving slot, the needle being positioned and maintained in the receiving slot by the housing.

5. The tip assembly as recited in claim 1 wherein the needle is substantially rigid and has a blunt tip provided at the distal end of the needle.

6. The tip assembly as recited in claim 1 wherein the needle has a stopper proximate the distal end of the needle, the stopper prevents a tip of the needle from penetrating an apex of the root canal of the tooth.

7. The tip assembly as recited in claim 1 wherein the housing has a tube receiving projection proximate the proximal end of the needle, the tube receiving projection having a circumferentially extending barb which cooperates with tubing to maintain the tubing in position on the tube receiving projection.

8. The tip assembly as recited in claim 1 wherein vibrations induced on the needle by the ultrasonic energy through the threaded insert are amplified due to the free vibration at the tip of the needle.

9. The tip assembly as recited in claim 1 wherein the distal end of the needle vibrates at resonant frequency, providing optimum energy to the fluid which is delivered to the root canal of the tooth, thereby providing optimum cleaning.

10. A consumable tip assembly for use with a dental tool which has an ultrasonic energy generator positioned therein, the tip assembly comprising:
an insert for attaching to the dental tool, the insert having a needle receiving portion;
a needle having a passageway extending therethrough from a proximal end of the needle to a distal end of the needle, the passageway providing a single continuous flow path for delivering fluid from a reservoir at the proximal end of the needle to a root canal of a tooth at the distal end of the needle;
a housing molded over at least a portion of the needle, the housing cooperating with the needle to maintain the needle in position relative to the needle receiving portion of the insert, the housing having a fluid receiving projection in which the proximal end of the needle is positioned;
the needle receiving portion and the needle are planar;
whereby the energy generated by the ultrasonic energy generator is translated into movement of the needle, the movement of the needle being planar to a longitudinal axis of the needle to provide optimum cleaning to the root canal.

11. The consumable tip assembly as recited in claim 10 wherein the insert includes a threaded housing having a first planar surface which can be threadably attached to the dental tool, a needle positioning member extending from the threaded housing in a direction away from the first planar surface, the needle receiving portion positioned at the end of the needle positioning member.

12. The consumable tip assembly as recited in claim 11 wherein the needle has a straight portion and a S-shaped portion, the S-shaped portion cooperates with the needle receiving portion of the insert.

13. The consumable tip assembly as recited in claim 12 wherein the receiving portion has a needle receiving slot, the needle being positioned and maintained in the receiving slot by the housing.

14. The consumable tip assembly as recited in claim 13 wherein vibrations induced on the needle by the ultrasonic energy through the threaded insert are amplified due to the free vibration at a tip at the ,distal end of the needle.

15. The consumable tip assembly as recited in claim 13 wherein the distal end of the needle vibrates at resonant frequency, providing optimum energy to the fluid which is delivered to the root canal of the tooth, thereby providing optimum cleaning.

16. A tip assembly for use with a dental tool which has an ultrasonic energy generator positioned therein, the tip assembly comprising:
an insert for attaching to the dental tool, the insert having a receiving portion;
a needle having a passageway extending therethrough from a proximal end of the needle to a distal end of the needle, the passageway providing a single continuous flow path for delivering fluid from a reservoir at the proximal end of the needle to a root canal of a tooth at the distal end of the needle;
the insert cooperating with the needle to transfer ultrasonic energy from the ultrasonic energy generator through the insert to the needle;
whereby the fluid has ultrasonic energy imposed thereon as it passes through the needle.

17. The tip assembly as recited in claim 16 wherein vibrations induced on the needle by the ultrasonic energy through the threaded insert are amplified due to the free vibration at a tip of the needle.

18. The tip assembly as recited in claim 16 wherein the distal end of the needle vibrates at resonant frequency, providing optimum energy to the fluid which is delivered to the root canal of the tooth, thereby providing optimum cleaning.

19. The tip assembly as recited in claim 16 wherein the insert includes a threaded housing having a first planar surface which can be threadably attached to the dental tool, a needle positioning member extending from the threaded housing in a direction away from the first planar surface, the receiving portion positioned at the end of the needle positioning member.

20. The tip assembly as recited in claim 16 wherein the needle has a straight portion and a S-shaped portion, the S-shaped portion cooperates with the receiving portion of the insert.
